(19) United States
(12) Patent Application Publication
(10) Pub. No.: US 2009/0204844 A1
(43) Pub. Date: Aug. 13, 2009

(54) ERROR-TOLERANT PROCESSOR SYSTEM

(76) Inventors: Werner Harter, Illingen (DE); Thomas Kottke, Ehningen (DE); Yorck von Collani, Beilstein (DE); Christian El Salloum, Wien (AT)

Correspondence Address: KENYON & KENYON LLP, ONE BROADWAY, NEW YORK, NY, 10004, US

(21) Appl. No.: 12/158,771

(22) PCT Filed: Dec. 12, 2006
(86) PCT No.: PCT/EP06/69610

§ 371 Date: Oct. 7, 2008

(30) Foreign Application Priority Data
Dec. 22, 2005 (DE) 10 2005 061 394.2

(51) Int. Cl. G06F 11/07

(52) U.S. Cl. 714/2; 714/E11.023

(57) ABSTRACT

A processor system includes at least one execution unit for executing program instructions of an application, a program memory for storing the program instructions of the application and at least one error handling routine, a main memory for storing a set of variables of the application and a monitoring unit for detecting errors of the execution unit and/or of the main memory, and the starting of an error handling routines in case an error is detected. The error handling routines are designed in each case to refresh different subsets of the set of variables.

### FIELD OF THE INVENTION

The present invention relates to a processor system having at least one execution unit for executing program instructions of an application, a program memory for storing the program instructions of the application and at least one error handling routine, a main memory for storing a set of variables of the application and a monitoring unit for detecting errors of the execution unit and/or of the main memory, and the starting of one of the error handling routines in case an error is detected.

### BACKGROUND INFORMATION

The errors whose detection is involved, in this instance, are “spontaneous” errors which occur occasionally and unpredictably in a system otherwise working properly. Such errors frequently originate from ionizing radiation, which releases charge carriers in the semiconductor material of the system, and is thus able to lead to uncontrolled charge movements. In the future one may expect a tightening of problems connected with spontaneous errors in digital circuit configurations, since progressive miniaturization of circuit configurations leads to increased sensitivity to ionizing radiation. The charge quantities, which make the difference between two different logical levels of a modern, highly integrated circuit, are meanwhile so low that a single quantum of ionizing radiation that is absorbed by a semiconductor structure may be enough to invert its logical state. The smaller the structures, and, thus, the smaller the charges, the more probable are such spontaneous state transitions, which are also designated as bit-flips.

A processor system of the above type is described in U.S. Pat. No. 6,625,749. A processor system is involved, in this instance, having two execution units and one test unit, the one execution unit and the test unit together being seen as a monitoring unit for monitoring the respectively other execution unit by comparing the results received from the processing units in response to the execution of the same program instructions. When different processing results of the two execution units are detected, which point to an error in one of the execution units, an error handling routine is started, during the course of which, from state data of the two execution units, a set of error-free state data is backed up in the main memory, and is subsequently uploaded to both execution units.

This processor system achieves a considerable measure of error tolerance, independently of the type of application executed by it, but the costs of the system are also considerable, based on the redundancy of the execution units.

It is true that these costs may be avoided by having non-redundant processor systems, but these have the problem that the handling of data detected to be corrupted is not possible with certainty, because after the occurrence of an error, one cannot be sure that the execution unit of such a system is still working correctly, and is in a position to reconstruct a data value detected as being corrupt, even when redundant information required for its reconstruction is available. Therefore, if an error occurs, the usual processor systems frequently block the execution of an application in which the error has occurred, or they automatically trigger a restart, whereby, taking into account the loss of all current values of variables of the application, a well-defined initial state is produced again, starting from which the system is in a position to continue to work correctly.

Such a restart is usually triggered by applying a reset signal to a reset input of the processor. While such a reset signal is also generated when the system is switched on, the same initialization procedure is executed when switching on the system as well as in the case of a restart.

These design approaches, too, are not fully satisfactory since, especially in the case of real time applications, a sudden blocking of the application or a restart, after which the system requires a longer time, frequently several hundred milliseconds to be usable again, are unacceptable.

### SUMMARY

Thus there is believed to be a need for a processor system which has a high degree of tolerance for spontaneous bit errors, in conjunction with a simple design that may be implemented cost-effectively.

Example embodiments of the present invention satisfy this requirement by a processor system having at least one execution unit for executing program instructions of an application, a program memory for storing the program instructions of the application and at least one error handling routine, a main memory for storing a set of variables of the application and a monitoring unit for detecting errors of the execution unit and/or of the main memory, and the starting of an error handling routine in case an error is detected, in which the main memory includes a plurality of error handling routines which are designed to refresh respectively different subsets of the set of variables.

The plurality of error handling routines makes it possible to react flexibly to an occurring error and rapidly to reinstate the utilization readiness of the system, since the entire set of variables does not have to be refreshed, which is different from the case of a usual restart.

At least some of the error handling routines preferably have a higher priority or lower priority relationship to one another, in response to the occurrence of an error, in each case the error handling routine, having the highest priority, being started. In such a system, the monitoring unit is preferably designed to judge whether an error was successfully removed by executing a higher priority error handling routine and, if it was not successfully removed, to start a lower priority error handling routine.

Different criteria may be used for judging that an error was not successfully removed. For instance, an error may be judged as having not been successfully removed if the error persists within a specified time period from the starting of the higher priority error handling routine. Another expedient criterion is whether the monitoring unit detects an error once again, within a specified time period from the carrying out of the higher priority error handling routine.

The set of variables refreshed by a given error handling routine is preferably a real subset of the set of variables that are refreshed by an error handling routine that is of lower priority than the given error handling routine. This means that the interventions of the error handling routines, that have a priority relationship to one another and are executed one after another in response to unsuccessful error handling, in the set of variables become ever more far-reaching from one routine to the next, until finally, as the lowest priority error handling routine in the ranking sequence, a restart is able to be provided, that is, a process in which all current variable values are discarded and refreshed with the aid of presettings.

When the processor system is used for controlling a machine, it is expedient if an error is detected to select the error handling routine that is to be executed with the aid of at least one operating parameter of the machine. If, for example, the processor system is a motor vehicle control unit, and the machine is a motor vehicle, it may be expedient to make the decision, concerning an error handling routine that is to be executed, dependent on whether the vehicle is standing still or traveling or how fast it is traveling.

In order to cause the execution unit to start an error handling routine, the monitoring unit may be connected to an NMI input of the execution unit. Even a connection of the monitoring unit to a reset input of the execution unit is useful.

Furthermore, the monitoring unit may be connected to an I/O port of the execution unit. It may be provided that the execution unit regularly scans this port during normal operation, so as to determine whether there is an error that has to be removed; preferably the port may be used to transfer auxiliary information to the execution unit during the course of an error handling routine.

According to one preferred design, the execution unit has two groups of internal memory cells, the memory cells of the first group being able to be directly cleared by a signal applied to a warm start input of the execution unit, but not those of the second group. Whereas, in response to a reset, usually all internal memory cells of an execution unit are cleared directly by the reset signal, without requiring the execution of special clear instructions by the execution unit, the presence of the two groups of memory cells provides the programmer of an application with the possibility of apportioning the variables of the application to the memory cells of the first and the second group in such a way that variables requiring much effort to refresh are located in memory cells of the second group, and those that may be refreshed without a problem are located in the first group.

A signal that indicates the presence or the absence of an error in the processor system, preferably has a level that is close to ground if there is an error, and a level that is far from ground if no error is present. Thus there is a great probability that the failure of a circuit part supplying this signal, for instance, because of a supply voltage failure, brings on the same reaction as an error to be detected by this circuit part, and is noticed thereby and is able to be removed.

An even greater reliability in the detection of an interference in the circuit part generating the error signal is achieved if this signal assumes a constant level when an error is present and a variable level in the absence of an error.

Other features and advantages of the present invention are derived from the following description of exemplary embodiments in light of the enclosed figures.

### BRIEF DESCRIPTION OF THE DRAWINGS

FIGS. 1-3 block diagrams of processor systems according to example embodiments of the present invention; and

FIG. 4 a flow chart of a working method of a monitoring unit in a processor system according to example embodiments of the present invention.

### DETAILED DESCRIPTION

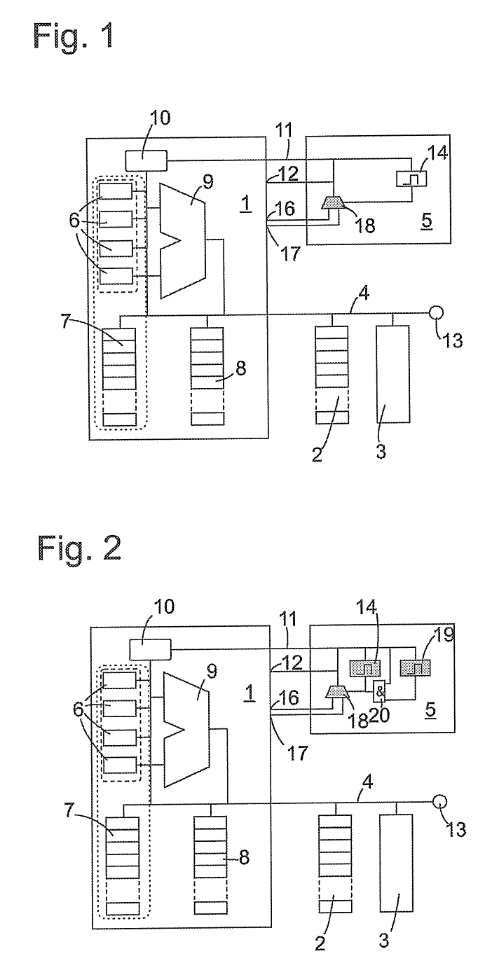

FIG. 1 shows schematically a processor system having a microprocessor 1, an external RAM 2 and ROM 3 which communicate with microprocessor 1 via a data bus 4 and an address bus that is not shown, as well as a monitoring unit 5. Microprocessor 1 includes a plurality of registers 6 as well as internal storage areas 7, 8 having random access, such as a cache, an arithmetic logic unit (ALU) 9, which carries out calculating operations on the contents of registers 6 and memories 2, 7, 8, a parity generator 10, sensors 13 for monitoring a machine controlled by the processor system and actuators via which the system is in a position to influence the machine. Components of microprocessor 1 which control the access of microprocessor 1 to program instructions stored in ROM 3, and their decoding, are not shown, although they are known per se. Registers 6 and internal storage areas 7, 8, and optionally also RAM 2, include a parity bit for each of their memory cells, which gives the parity state of the data word stored in the cell. The parity bit is output with the associated data word to data bus 4, but is not processed by ALU 9. It is received by monitoring unit 5 and compared to a parity bit which the latter calculates from the simultaneously received associated data word.

In response to non-agreement of the parity bits, parity generator 10 outputs an error signal to monitoring unit 5, on a line 11.

During orderly functioning of microprocessor 1, signal line 11 carries a level logical 1, close to the supply potential of the microprocessor; when there is a parity error, the level drops to logical 0, close to ground potential. As a result, not only is an actual bit error detected in the memory monitored by monitoring unit 5, but an interference in the monitoring unit itself, at which its output signal goes to 0, is also detected as an error. The error signal is fed back by monitoring unit 5 directly to a non-maskable interrupt input (NMI input) 12 of microprocessor 1. Thus, in the error case, microprocessor 1 is forced to interrupt the application that is being processed and to activate an NMI error handling routine.

According to one variant, at an orderly functioning of microprocessor 1, signal line 11 carries a signal whose level oscillates between logical 0 and logical 1, and which assumes a constant value in the error case. Thus, the case in which monitoring unit 5 constantly outputs an output signal logical 1, because of an interference, is also detected as an error.

The error handling routine may, for instance, consist in ascertaining in which of several program parts of the application, running on the microprocessor, the error, that has been established, has occurred, and subsequently to execute an error handling routine that is specific to the respective program part; this may consist in refreshing variables used by this program part and then to return to a specified reentry point of the respective program part, from which point on, one is able to work using the refreshed variables. The refreshing of the variables may, for instance, take place in that they are read out from a permanent memory, in the same manner as in a cold start of the processor system, and are copied to areas in memory 7, 8 provided for them, or in that they are freshly calculated from permanently stored values. If the processor system is being used for a control application, then, for many of the variables that correspond to operating variables of a machine that is controlled by the processor system, the simplest way to their refreshing is for microprocessor 1 to newly record them via the sensors 13 that correspond to them. In the one case as in the other, the set of data to be refreshed is limited to a part of the variables of the application, so that the readiness for use of the processor system is in most cases clearly restored faster than if a reset of the entire processor system takes place, along with a subsequent reinitialization of all the variables.

By variable one should understand in an inclusive sense, in this instance, every quantity stored in one of describable memories 2, 6, 7, 8, so that the microprocessor is technically in a position to change them, independently of whether the respective application actually provides for a change in such a variable or not.

A further possibility in error handling, after identification of the program part in which the error has occurred, is to block the execution of this program part and instead to activate a specified substitute program part which briefly makes possible a greater degree of operating security than the program part in which the interference occurred. If, for example, the application is a brake-by-wire system, it may be expedient, when an error occurs in a program part which is used to calculate and compare the speeds of the different wheels of a vehicle, to block an antilock function based on this comparison, and instead to activate an emergency function which controls the brake pressure acting on the wheels solely with the aid of the accelerator position, without taking into account possible locking of the wheels, so as not to impair, in this manner, the availability of the brakes in the traveling vehicle by a time-consuming cold start of the processor system.

According to one refinement that will also be described with reference to FIG. 1, input 12 of microprocessor 1 is not an NMI input but an I/O port. A signal coming in to this port from monitoring unit 5 causes no automatic reaction of microprocessor 1, but microprocessor 1, being program-controlled, is in a position to read the level of input 12. The NMI input is designated as 16; other than that, the same reference symbols are used for the same elements as in the previously described embodiment. NMI input 16 and a reset input 17 are connected to error signal line 11 via a demultiplexer 18 within monitoring unit 5. Demultiplexer 18 is controlled by a timer, in this case a monoflop 14 which is put into its unstable state by the arrival of an error signal on line 11. In this state, it controls multiplexer 18 in such a way that the latter switches over the error signal to NMI input 16 of microprocessor 1, which triggers there an error handling routine as was described above for the first embodiment.

Monoflop 14 is not able to be triggered anew by the vanishing and reappearing of the error signal in the meantime, so that it returns to the stable state independently of whether the error signal is removed by the error handling routine or not, after a specified time interval dt1. In this state, demultiplexer 18 connects reset input 17 of microprocessor 1 to error signal line 11. If the error signal has disappeared meanwhile, this does not lead to any reaction of microprocessor 1; however, if it is still present, that is, if the error handling routine triggered via the NMI input within time dt1 has shown no effect, it is regarded as having failed, and the error signal is applied to the reset input.

Because of the error signal at reset input 17, which is designated also as reset signal below, at least registers 6 of microprocessor 1 are directly erased. Depending on the type of construction of microprocessor 1 it may be provided that internal storage areas 7, 8 are also to be directly erased.

Moreover, microprocessor 1 is induced by the reset signal to activate a further error handling routine in ROM 3. At the beginning of this routine it checks the status of input/output connection 12. If this does not indicate an error, a cold start is involved; in this case, in the same manner as with switching on the system, among memories 2, 6, 7, 8 all those that have not been erased automatically by the reset signal are newly initialized under program control, auto-test routines are carried out, etc.

If, however, an error signal is present at I/O port 12, microprocessor 1 detects from it that there is no cold start, and the error handling routine that is then executed limits itself to refreshing the storage locations erased by the reset signal, that is, registers 6 and possibly memories 7, 8.

In the case of a microprocessor in which not the entire internal memory 7, 8 is automatically erased by the reset signal, it may also be ascertained, analogously to the above-described first embodiment, in which program part of the application the error occurred, and subsequently an error handling routine specific to this program part may be selected and executed, which only refreshes one area used by this program part, for instance, area 7, but not an area 8 used only by other program parts.

The microprocessor system of FIG. 2 differs from the second embodiment by a second monoflop 19, which is connected to error signal line 11 in parallel to first monoflop 14, but has a clearly longer duration dt2 of unstable state than the duration dt1 of monoflop 14. This time duration is greater than would be required for executing the error handling routine triggered via NMI input 16, so that the unstable state continues for a while longer if the processor system returns to the application after the error handling routine. An AND gate 20 has inputs connected to the output of monoflop 19 and error signal line 11, and an output which controls demultiplexer 18 in parallel with monoflop 14. The effect of this embodiment is that, when an error in microprocessor 1 has been detected by parity generator 10, this error still remains stored for a certain time in monoflop 19, even if it was at first apparently successfully removed by the triggering of an error handling routine via NMI input 16. If a second error is detected after such an error within the latency period of monoflop 19, there is a great probability that a causal connection between the two exists, and the error handling routine triggered via NMI was not sufficient, so that a lower-reaching error handling is immediately triggered via the reset input.

Instead of being connected to the processor-internal part of data bus 4, parity generator 10 may also be connected directly to the individual registers 6, as well as possibly also to at least one part 7 of the cells of the internal memory of the microprocessor, in order to detect parity errors occurring there the moment they appear, and not first at the point in time when they are output during the course of a read access to data bus 4.

FIG. 3 shows a further development of such a microprocessor system having two parity generators 10a, 10b, of which the one, 10a, is assigned to registers 6 and the other, 10b, is assigned to storage area 7. Corresponding to the two parity generators, there are also two error signal lines 11a, 11b that lead to monitoring unit 5. Only line 11a is connected, in a manner analogous to the second embodiment, to monoflop 14 and demultiplexer 18, in order, in the error case, to respond to NMI input 16 of the processor. For this reason, refreshing registers 6 is sufficient in the case of an error handling routine triggered via the NMI. Only when these do not make the error disappear during the latency period of monoflop 14 is a second error handling routine, that goes further, triggered via reset input 17. This error handling routine also refreshes the content of storage area 7. In the case of a parity error in storage area 7, the second error handling routine is immediately triggered via the reset input.

As is easily seen, the concept of graded reaction to errors of the microprocessor, described above in conjunction with examples, is suitable for diverse refinements which are easy to implement, particularly with a monitoring unit 5 that is program-controlled on their part. Such a program-controlled monitoring unit may be a second processor within the scope of a multiprocessor system, in such a system the processors preferably monitoring each other in turn. However, it is also conceivable in a monoprocessor system that one might implement monitoring unit 5 as an interrupt routine invoked by parity generator 10.

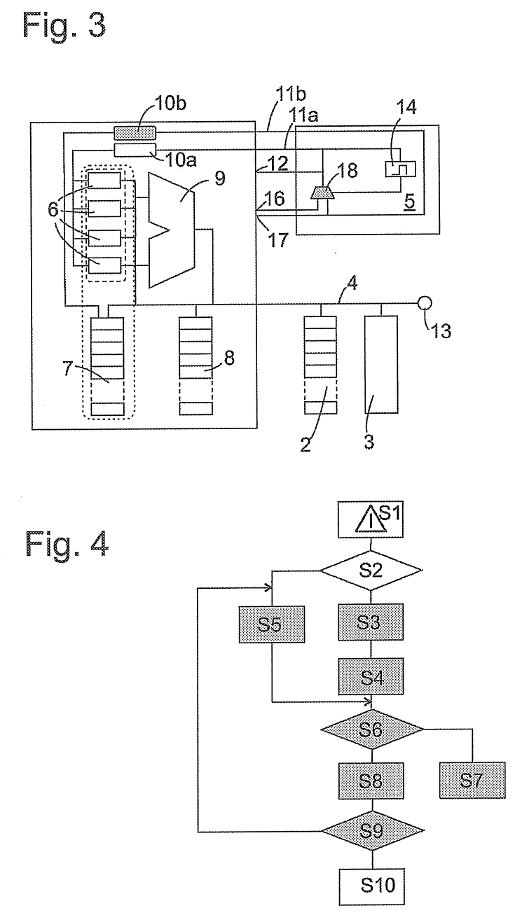

The flow chart of FIG. 4 shows the method of operation of a software implementation of monitoring unit 5, whether in microprocessor 1 itself or in another processor. The routine begins in step Si with the recording of an error reported by the parity generator. In step 2, the state of a timer is scanned which was possibly set by an earlier error handling, in order to determine whether the latency of an error that occurred earlier is still continuing, that is, whether a causal connection between this earlier error and the currently observed error should be assumed.

If this is not the case, the origin of the error is ascertained in step S3. If the parity generator is monitoring the data bus, a program part may be ascertained in which the error has occurred, with the aid of a program counter reading which was saved to the stack at the time of the interrupt.

Alternatively, in a construction of the type shown in FIG. 3, which monitors registers 6 and internal memories 7, 8, or even individual areas 7, 8 of the memory separately, it may be established where in the memory the error has occurred. Using appropriate association of the memory areas with partial programs of the application, both attempts are able to yield the same result.

A suitable error handling routine is selected in step 4 with the aid of the ascertained error origin. That is, among several error handling routines which may be suitable for removing an error having the established origin, the one having the highest priority is first selected. This is that error handling routine which represents the least intervention in the system, that is, in general it is the one which refreshes the smallest number of variables and may be executed the fastest.

If, in step S2, it is established that the latency period is still continuing, an error handling routine is selected in step S5 which follows in priority the previously executed error handling routine. That is, since it may be assumed that the previous error handling routine has remained without success, the next most productive one is tried.

The error handling routine selected in step S4 or S5 is checked in step S6 for admissibility. For this, for instance, an operating variable of the controlled machine, for example, the speed of the vehicle controlled by the processor system is recorded, and with the aid of a table previously stored in ROM 3, it is checked whether the selected error handling routine is permitted or forbidden in the case of the recorded value of the operating variable. If it is forbidden, for instance, because carrying it out would occupy the processor for an excessively long time at the measured speed, it is not executed, and processor 1 changes to an emergency mode S7.

If the error handling routine in step S6 is found to be admissible, it is started in step S8. Then a time span dt1 in length is awaited, and it is subsequently checked in step S9 whether the parity generator continues to report the error or not. If the error continues to be present, the method returns to step S5, in order to execute the routine following in priority sequence the error handling routine that has just been tried. If the error is no longer observed in step 9, the method ends in step 10 with setting the timer that was scanned in step 2.

It should be understood that, for the transition from step S9 to S5, a function following in the priority sequence is only able to be selected for as long as one is present. The last routine in each priority sequence of the error handling routines is the cold start, of necessity.

1-13. (canceled)

14. A processor system, comprising:
at least one execution unit configured to execute program instructions of an application;
a program memory configured to store program instructions of the application and at least one error handling routine;
a main memory configured to store a set of variables of the application; and
a monitoring unit configured to detect errors of at least one of (a) the execution unit and (b) the main memory and to start an error handling routine in case an error is detected;
wherein the error handling routines are arranged in each case to refresh different subsets of the set of variables.

15. The processor system according to claim 14, wherein the monitoring unit is configured to detect bit errors in at least one of (a) registers of the execution unit and storage cells of the main memory.

16. The processor system according to claim 14, wherein an order of priority of the error handling routines is specified; and the monitoring unit is configured to judge whether an error was successfully removed by executing a higher priority error handling routine and, if it was not successfully removed, to start a lower priority error handling routine.

17. The processor system according to claim 16, wherein the error is judged as having not been successfully removed if the error persists within a specifiable time period from the starting of the higher priority error handling routine.

18. The processor system according to claim 16, wherein the error is judged as having not been successfully removed if the monitoring unit detects an error once more within a specifiable time period from the carrying out of the higher priority error handling routine.

19. The processor system according to claim 16, wherein the set of variables refreshed by a given error handling routine is a proper subset of the set of variables that are refreshed by an error handling routine that is of lower priority than the given error handling routine.

20. The processor system according to claim 14, wherein it is used for controlling a machine and is prepared, if an error is detected, to select the error handling routine that is to be executed with the aid of at least one operating parameter of the machine.

21. The processor system according to claim 14, wherein the monitoring unit is connected to an NMI input of the execution unit.

22. The processor system according to claim 14, wherein the monitoring unit is connected to a reset input of the execution unit.

23. The processor system according to claim 14, wherein the monitoring unit is connected to an I/O port of the execution unit.

24. The processor system according to claim 14, wherein the execution unit has two groups of internal storage cells, those of the first group being directly erasable by a signal applied to an input of the execution unit, and those of the second group not being so.

25. The processor system according to claim 14, wherein a signal indicating the presence or the non-presence of an error assumes a level close to ground when an error is present, and a level far from ground when an error is not present.

26. The processor system according to claim 14, wherein a signal indicating the presence or the non-presence of an error assumes a constant level when an error is present, and a variable level when an error is not present.
